(19) United States
(12) Patent Application Publication
(10) Pub. No.: US 2026/0140228 A1
(43) Pub. Date: May 21, 2026

(54) SENSOR MODULE WITH ENVIRONMENTAL SENSOR AND CLEANING DEVICE

(71) Applicant: Webasto SE, Stockdorf (DE)

(72) Inventor: Magnus SVIBERG, Stockdorf (DE)

(21) Appl. No.: 19/389,630

(22) Filed: Nov. 14, 2025

(30) Foreign Application Priority Data
Nov. 18, 2024 (DE) 10 2024 133 691.9

(51) Int. Cl. G01S 7/40; B60J 10/25; B60J 10/70; B60S 1/52; B60S 1/56; G01S 13/931

(52) U.S. Cl. CPC G01S 7/4043; B60J 10/25; B60S 1/52; B60S 1/56; G01S 13/931; B60J 10/70; G01S 2013/9323; G01S 2013/9324

(57) ABSTRACT

A sensor module for a motor vehicle has an environment sensor, a viewing region through which the environment sensor can capture a vehicle environment, and a cleaning device which has a cleaning nozzle for cleaning the viewing region. The cleaning device moreover has a flow guidance element which can be adjusted between a rest position and a cleaning position relative to the cleaning nozzle and/or the viewing region. The flow guidance element forms in the cleaning position at least one gap for managing the cleaning fluid and/or for guiding the flow of the cleaning fluid.

### CROSS-REFERENCE TO RELATED APPLICATION(S)

This application claims the benefit of German Application No. DE 10 2024 133 691.9, filed Nov. 18, 2024, which is incorporated herein by reference in its entirety.

### TECHNICAL FIELD

The invention relates to a sensor module with an environment sensor and a cleaning device. The invention moreover relates to a motor vehicle which comprises at least one such sensor module.

### BACKGROUND

Vehicle roofs are known in practice. A vehicle roof can be designed, for example, as a roof sensor module which can be placed as a separate component on a vehicle body, forming a vehicle bodyshell, of a car. As an interface with the vehicle roof, the vehicle body comprises roof posts which can take the form of longitudinal posts and/or transverse posts and constitute a support system on the vehicle bodyshell. The vehicle roof comprises a roof skin which forms an outer visible surface and has sensor viewing regions through which the environment sensors, which serve to capture a vehicle environment and are arranged underneath the roof skin, can capture the vehicle environment.

Self-driving or partially self-driving vehicles comprise, for example, a roof designed as a roof sensor module (RSM) which is equipped with a plurality of environment sensors. The environment sensors, which are integrated in a dry region into the vehicle roof designed in particular as a roof sensor module and which are designed, for example, as lidar sensors and/or as radar sensors and/or as cameras, capture the surroundings around the vehicle and make corresponding measurement signals available to control electronics of the relevant vehicle such that a respective traffic situation can be identified and the driving behavior of the relevant vehicle can be adapted to this traffic situation. The environment sensors can here be arranged, for example, retractably and extendably or rigidly on the roof skin.

In order to enable fault-free capturing of the vehicle surroundings as possible, it is known to keep a viewing region, through which the environment sensor looks in order to capture the vehicle environment, free of optical interference such as drops of water and/or particles of dirt. The viewing region can be formed directly on the environment sensor and, for example, in the form of a lens. Alternatively or additionally, the viewing region can also be provided in a cover of the environment sensor which can be part of a sensor housing or another body part.

Various cleaning devices are known for cleaning the viewing region. The cleaning can be effected, for example, by means of compressed air or by another cleaning fluid.

When driving with the vehicle, the wind which occurs from driving often adversely affects the cleaning performance of the cleaning device. Moreover, the cleaning fluid used for the cleaning can possibly drain over the windshield, which adversely affects the view of the driver and makes the windshield dirty. This situation is even more acute in the case of fully self-driving vehicles because such vehicles no longer have windshield wipers or cleaning devices for cleaning the windshield.

### SUMMARY

The object of the invention is to provide a sensor module with an improved cleaning device.

The object is achieved by a sensor module with the features of claim 1.

Advantageous embodiments of the invention are the subject of the dependent claims. All combinations of at least two features disclosed in the description, the claims, and/or the Figures fall within the scope of the invention. It is understood here in particular that customary linguistic variants and/or the analogous replacement of respective concepts as part of customary linguistic practice, in particular the use of synonyms supported by the generally accepted linguistic literature, are comprised by the content disclosed in this document without their respective formulation being explicitly mentioned.

In a first aspect, a sensor module is proposed for a motor vehicle. The sensor module has an environment sensor, a viewing region through which the environment sensor can capture a vehicle environment, and a cleaning device which has a cleaning nozzle for cleaning the viewing region. The cleaning device moreover has a flow guidance element which can be adjusted between a rest position and a cleaning position relative to the cleaning nozzle and/or the viewing region, wherein the flow guidance element forms in the cleaning position at least one gap for managing the cleaning fluid and/or for guiding the flow of the cleaning fluid.

It should be understood that the sensor module can have at least one environment sensor. It should be understood that the sensor module can have at least one cleaning nozzle. It should be understood that the sensor module can have further functional components, in particular an air-conditioning device for air-conditioning the environment sensor and/or a lighting device and/or other cleaning components. Functional components of this type can be arranged on a sensor module frame. The environment sensor can have a lidar sensor and/or a radar sensor and/or an ultrasound sensor and/or an infrared sensor and/or a camera sensor. The environment sensor can be designed as fixed or retractable and extendable, or adjustable, relative to a surface component or a roof skin of the motor vehicle. In the present document, the term motor vehicle is used synonymously with the term vehicle.

The sensor module of the present document enables, by virtue of the flow guidance element which is preferably guided movably, at least partial covering of the cleaning nozzle(s) in the cleaning position. As a result, aerodynamics or aerodynamic behavior of a spray jet of the at least one cleaning nozzle are improved. Moreover, an opening or the gap relative to the viewing region and through which the spray jet of the cleaning nozzle can be directed onto the viewing region can be formed by the flow guidance element. Moreover, a further opening or a further gap for managing water can preferably be formed by the flow guidance element, in particular between the sensor module and the windshield.

The sensor module of the present document improves the styling of the vehicle. The sensor module of the present document moreover improves visibility or a view for a driver through the windshield because the management of the water can prevent cleaning fluid of the cleaning nozzle from running onto the windshield. Moreover, viewing through the viewing region can be improved for the environment sensor by the improved aerodynamics. The sensor module of the present document improves the structural space for the motor vehicle. Moreover, a cleaning function for cleaning the viewing region can generally be improved by the sensor module. The sensor module of the present document moreover results in increased stability. Tolerances can also be reduced. The setting/calibration of the cleaning device can also be improved. Overall, the sensor module has a lower degree of complexity, which in turn results in lower costs. A saving in weight can also be achieved.

In a further aspect, it is proposed that the flow guidance element is arranged, in the rest position, at least in some regions flush with a surface component, adjoining the sensor module, of the motor vehicle. Alternatively or additionally, it is proposed that the flow guidance element, in the rest position, adjoins an upper edge, at the roof, of a windshield of the motor vehicle in particular gap-free.

In the mounted state of the sensor module, the surface component of the motor vehicle adjoins the sensor module at least in some regions. It is also possible that the surface component forms part of the sensor module. The flow guidance element can preferably adjoin the surface component directly or, for example, by means of a seal. The flow guidance element can have or at least partially form the seal. The seal can, for example, have a seal of the windshield. The flow guidance element is, in the rest position, preferably situated “in a line”, i.e. flush and gap-free, i.e. with no gap, with the outside of the vehicle or an upper edge of the windshield.

In a further aspect, it is proposed that the flow guidance element, considered in a vehicle longitudinal direction, has a larger spacing from the viewing region in the rest position than in the cleaning position.

The flow guidance element is thus preferably moved from the rest position into the cleaning position in the direction of the viewing region and preferably away from an upper edge, at the roof, of the windshield of the motor vehicle. In the cleaning position, the flow guidance element is preferably situated in a position in which a gap which is created between the flow guidance element and the outside of the vehicle or the upper edge of the windshield.

In a further aspect, it is proposed that the flow guidance element can be moved between the rest position and the cleaning position essentially in a vehicle longitudinal direction. The flow guidance element can in principle also be moved at least partially in a vehicle vertical direction between the rest position and the cleaning position. The movement of the flow guidance element can here include, for example, a rotational and/or a translational movement.

In a further aspect, it is proposed that the flow guidance element, in the cleaning position, delimits the at least one gap or an opening with respect to the viewing region or relative to the viewing region, in particular with respect to or relative to a lower edge of the viewing region, and/or relative to an upper edge, at the roof, of a windshield of the motor vehicle, wherein the at least one gap is designed for managing the cleaning fluid and/or guiding the flow of the cleaning fluid.

In the cleaning position, the flow guidance element preferably forms a first gap with respect to the viewing region, and a second gap with respect to the upper edge, at the roof, of the windshield. The gap can have different or identical gap widths.

In a further aspect, it is proposed that the sensor module moreover has a sensor module frame which can be connected to the vehicle body component or can be formed integrally with the vehicle body component.

The sensor module frame can at least in some regions form a fluid collecting container by which a cleaning fluid which can be used by the cleaning nozzle for cleaning the viewing region can be caught and can preferably be channeled away via a drain from the sensor module and/or the motor vehicle, for example via a vehicle body component.

The fluid collecting container makes it possible for the cleaning liquid and the dirt contained therein to be discharged from the sensor module. The drain can, for example, interact with a body frame or another drainage channel and thus enable the discharging or the draining of the cleaning fluid from the motor vehicle. The sensor module frame is preferably rigidly connected to a vehicle body of the motor vehicle or formed at least partially by the vehicle body. The sensor module frame is preferably unable to move relative to the vehicle body. The sensor module frame can be part of the vehicle body. The sensor module frame preferably forms, together with the vehicle body or a separate container, an in particular watertight or liquid-impermeable surface or barrier between the exterior and the interior of the motor vehicle. The vehicle body or the separate container, or also the sensor module frame itself, preferably have a water drainage opening or a separate water drain in order to allow the collected cleaning fluid or the cleaning liquid to be drained from the motor vehicle. The sensor module frame can in particular form an at least partially trough-shaped region by which the cleaning liquid can be caught and/or collected.

The sensor module frame is preferably rigidly connected (immovably) to the vehicle and forms, together with the body or a separate trough, a watertight surface between the exterior and the interior of the vehicle. The body or the separate trough preferably have a water drainage surface and/or in particular separate water drains in order to drain off the water and/or cleaning fluid collected in the body or a separate trough. Moreover, (environment) sensors, lights, and/or similar and/or further components can be mounted at or on the sensor module frame, for example also together with other components such as heating and/or cooling and/or cleaning components and/or electrical and/or electronic components. The at least one cleaning nozzle can moreover be mounted on the sensor module frame as part of the sensor module.

In a further aspect, it is proposed that the flow guidance element is arranged on the sensor module frame by means of an adjustment kinematic system and can be moved by the adjustment kinematic system between the rest position and the cleaning position.

The adjustment kinematic system preferably serves to guide the flow guidance element during the movement between the rest position and the cleaning position. The flow guidance element is preferably arranged or fastened on the sensor module frame so that it can be moved by means of the adjustment kinematic system, such that the flow guidance element can move relative to the sensor module frame and preferably also relative to a cover of the sensor module.

In a further aspect, it is proposed that the adjustment kinematic system has a hinge mechanism and/or a four-joint mechanism and/or a multiple-joint mechanism and/or a pushing mechanism and/or a sliding mechanism and/or a carriage mechanism and/or a spring/piston mechanism.

Purely by way of example, the movement of the cover or a part of the cover can be effected by a movement mechanism, wherein the list is not to be understood as limiting. In principle, any type of movement mechanism can be used to move the cover or the part thereof. Such a movement mechanism can, for example, have an electric motor with or without a spindle. Such a movement mechanism can, for example, have at least one lever which is, for example, fastened at one end at a motor shaft and at another end at the movable cover. A pivot point and/or sliding point between the lever and the movable cover can, for example, be chosen freely.

In a further aspect, it is proposed that the flow guidance element is designed as part of a seal, in particular as a section of a seal, of an upper edge, at the roof, of a windshield of the motor vehicle.

The flow guidance element can thus also be designed as part of the seal of the windshield. In this case, the seal is preferably divided into a stationary part which extends at least in some regions around the windshield, and a movable part which, considered in the viewing direction of the environment sensor, is arranged in front of the sensor module. The movable part of the seal by means of which the flow guidance element can be formed can in this way be integrated into the sensor module or form part of the sensor module. The seal of the windshield is thus complemented when the sensor module is arranged on the motor vehicle as a pre-assembled structural unit. In the rest position, the flow guidance element which forms part of the seal is preferably lowered and creates a seal between the windshield and/or the body of the vehicle and the sensor module. In the cleaning position, the flow guidance element is preferably raised and in this way opens a gap between the windshield and the sensor module which serves for managing the water. A lip in the seal can preferably be formed so as to channel away or guide the water or the cleaning fluid and thereby prevent the water or the cleaning fluid from running onto the windshield.

The flow guidance element can here preferably be moved between the rest position and the cleaning position essentially in a vehicle vertical direction.

The flow guidance element preferably forms, in the cleaning position, a gap relative to the upper edge of the windshield and/or to the surface component and/or to the sensor module, which serves to manage the cleaning fluid and/or to guide the flow of the cleaning fluid.

The flow guidance element has, considered in a vehicle vertical direction, a smaller spacing from the upper edge or the surface component in the rest position than in the cleaning position.

In the present document, a vehicle roof of a motor vehicle comprising at least one sensor module according to any embodiment is also claimed.

A preferred embodiment of the vehicle roof is designed as a roof sensor module. Such a roof sensor module forms in an integrated fashion a structural unit which accommodates components which are required for self-driving or partial self-driving of the relevant vehicle. The roof sensor module into which a plurality of functional elements can thus be integrated hence constitutes a compact structural unit which is connected by a vehicle manufacturer to a vehicle body or a vehicle bodyshell which comprises roof posts such as roof side posts and/or roof longitudinal posts. The vehicle roof, designed as a roof sensor module, thus constitutes a roof sensor module (RSM) which makes self-driving or partial self-driving of the relevant vehicle possible.

A motor vehicle which is equipped with such a vehicle roof and takes the form of a self-driving vehicle drives independently in self-driving mode, at least without significant intervention by a driver. In partial self-driving mode, the vehicle roof according to the invention forms, for example, part of a driver assistance system.

The vehicle roof can be provided with a transparent fixed roof section and/or a roof opening system for a roof opening.

In particular, the vehicle roof forms at least part of the roof of a car. It can, however, also be a roof of a commercial vehicle which takes the form, for example, of a delivery truck, a bus, a self-driving minibus such as a so-called people mover, or also the form of a truck traction unit.

A motor vehicle is also claimed in the present document which comprises a sensor module and/or a vehicle roof of the above-described type. The vehicle roof preferably forms a roof sensor module (RSM) which can be arranged as a pre-assembled structural unit on a vehicle body of the motor vehicle. In other words, in particular a vehicle bodyshell of the motor vehicle can thus be provided with a prefabricated or pre-assembled roof sensor module which is designed as a roof sensor module.

It should be understood that the embodiments and exemplary embodiments which are mentioned above and are to be explained below can be formed not only individually but also in any desired combination without going beyond the scope of the present invention. It should also be understood that the embodiments and exemplary embodiments which are mentioned above and are to be explained below relate in an equivalent or at least similar fashion to all embodiments of the invention without being mentioned separately in each case.

### BRIEF DESCRIPTION OF DRAWINGS

Embodiments of the invention are illustrated schematically in the drawings and are explained below by way of example.

FIG. 1 shows a schematic view of a motor vehicle with a vehicle roof on which a sensor module is arranged.

FIG. 2 shows an exemplary embodiment of a sensor module.

FIG. 3 shows an exemplary embodiment of a sensor module.

FIG. 4 shows an exemplary embodiment of a sensor module.

FIG. 5 shows an exemplary embodiment of a sensor module.

FIG. 6 shows an exemplary embodiment of a sensor module.

FIG. 7 shows an exemplary embodiment of a sensor module.

FIG. 8 shows an exemplary embodiment of a sensor module.

FIG. 9 shows an exemplary embodiment of a sensor module.

FIG. 10 shows an exemplary embodiment of a sensor module.

### DETAILED DESCRIPTION

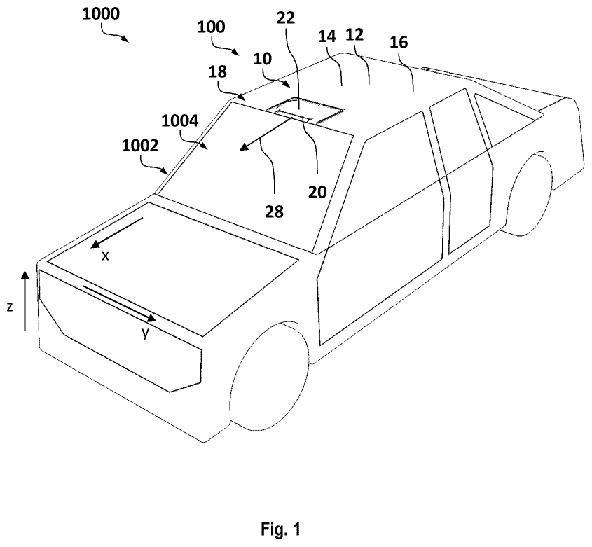

FIG. 1 shows schematically a motor vehicle 1000 which has a vehicle body 1002. The motor vehicle 1000 moreover has a roof sensor module 10 which is arranged as a pre-assembled structural unit on the vehicle body 1002 and forms a vehicle roof 100 of the motor vehicle 1000 at least in some regions. The motor vehicle 1000 moreover has a windshield 1004.

In alternative embodiments, the vehicle roof 100 can also be a vehicle roof which is not designed as a roof sensor module. All the embodiments thus also relate to such a vehicle roof 100.

The roof sensor module 10 comprises a surface component 12 which forms a roof skin 14 of the vehicle roof 100 at least in some regions. The roof sensor module 10 comprises, according to FIG. 1, a fixed roof element 16. In other or supplementary embodiments, the roof sensor module 10 can have a roof opening system which comprises a lid element which can be shifted to selectively open or close a roof opening.

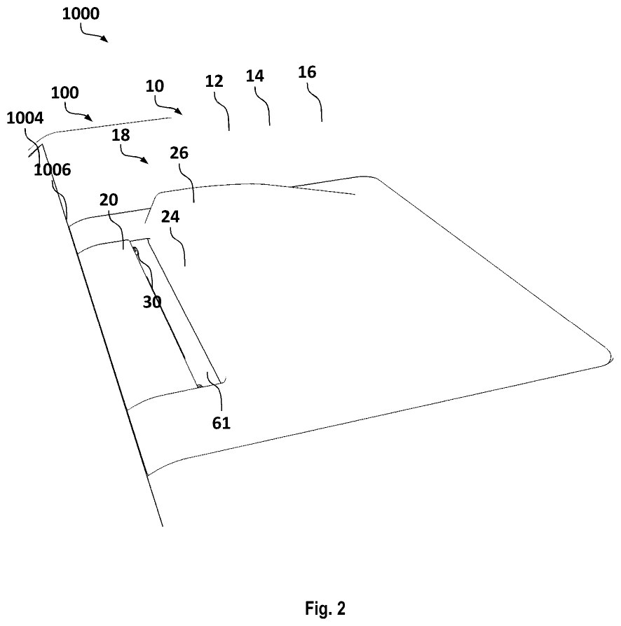

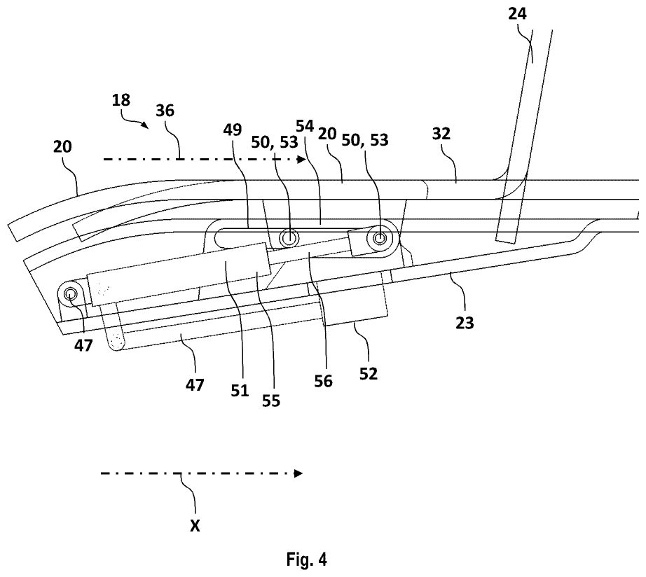

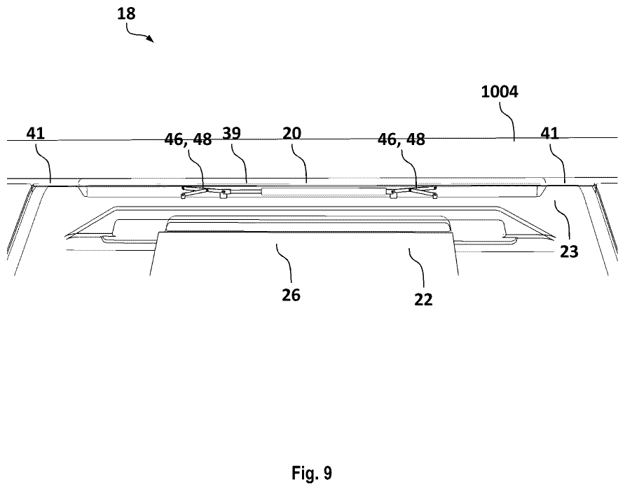

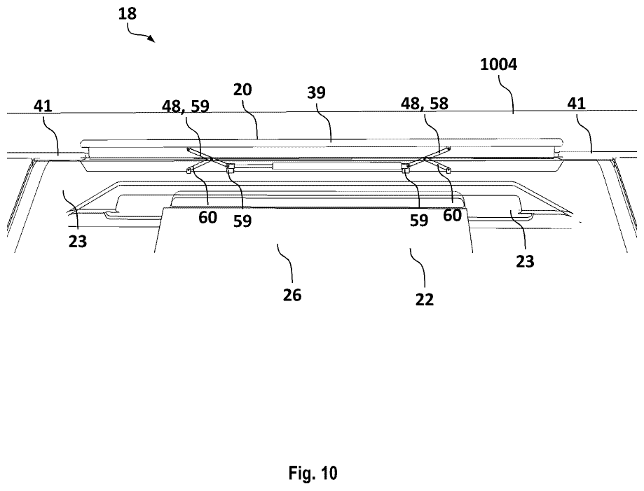

The motor vehicle 1000 has a sensor module 18 which in the present case is part of the roof module 10. The sensor module 18 can also be formed separately from the roof module 10. The sensor module 18 is shown in detail in at least partly different embodiments in the further FIGS. 2 to 10. The sensor module 18 has in the present case a cleaning device 19 which in the present case comprises a flow guidance element 20. The sensor module 18 moreover has at least one environment sensor 22 for capturing the environment of a vehicle. The environment sensor 22 is arranged on a sensor module frame 23 (see FIGS. 4 to 6).

The environment sensor 22 is configured to capture the environment of the vehicle via a viewing region 24. In the present case, the viewing region 24 is provided in a sensor housing 26. The viewing region 24 is provided as a window in an opening, not shown in more detail, of the sensor housing 26. The viewing region 24 can also be provided integrally in the sensor housing 20, or be arranged separately in or on the latter.

The environment sensor 22 can be a lidar sensor and/or a camera and/or a radar sensor and/or an ultrasound sensor and/or a multi-camera sensor. Other sensors are also conceivable. The environment sensor 22 is arranged in the sensor housing 26. The environment sensor 22 has an optical axis 28 which defines a main capturing direction or a viewing direction of the environment sensor 22. The optical axis 28 is in the present case oriented parallel to a vehicle longitudinal direction x. The vehicle longitudinal direction x is oriented orthogonally to a vehicle width direction y. A vehicle vertical direction z is oriented orthogonally to the vehicle longitudinal direction x and to the vehicle width direction y.

The cleaning device 19 moreover has a cleaning nozzle 30 for cleaning the viewing region 24. The flow guidance element 20 is adjustable between a rest position and a cleaning position relative to the cleaning nozzle 30 and/or the viewing region 24.

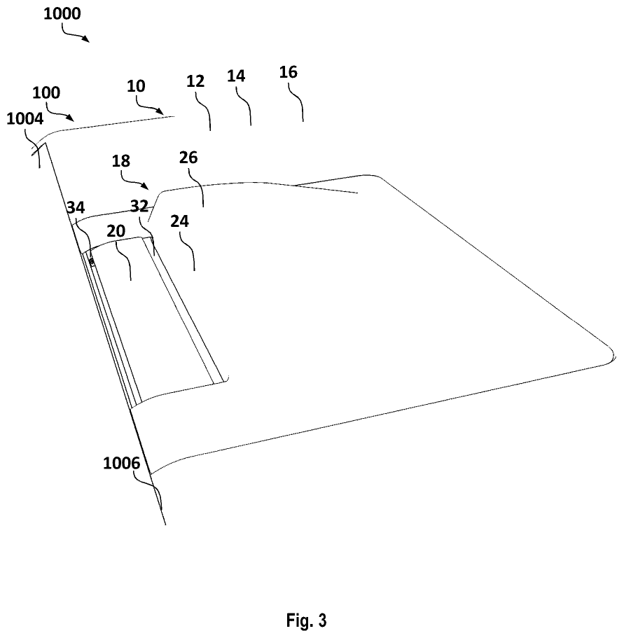

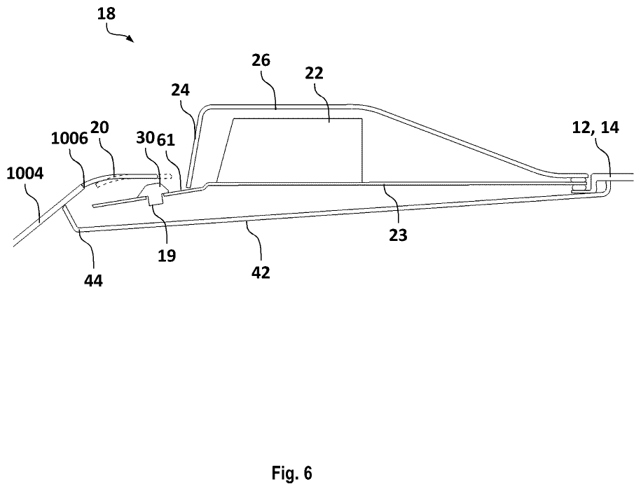

According to one embodiment, which is shown by way of example and in different variants in FIGS. 2 to 6, in the cleaning position the flow guidance element 20 forms a first gap 32 from the viewing region 24. In the cleaning position, the flow guidance element 20 moreover forms a second gap 34 relative to an upper edge 1006, at the roof, of the windshield 1004. The first and the second gap 32, 34 serve to manage the cleaning fluid and/or to guide the flow of the cleaning fluid (see FIG. 3). In the rest position, the flow guidance element 20 is arranged at least in some regions flush with the surface component 12, adjoining the sensor module 18, of the motor vehicle 1000 and adjoins the upper edge 1006, at the roof, of the windshield 1004 of the motor vehicle 1000 gap-free (see FIGS. 2 and 6). The flow guidance element 20 can be moved here between the rest position and the cleaning position in a movement direction 36 essentially in a vehicle longitudinal direction x. The flow guidance element 20 has, considered in a vehicle longitudinal direction x, a greater spacing from the viewing region 24 in the rest position than in the cleaning position.

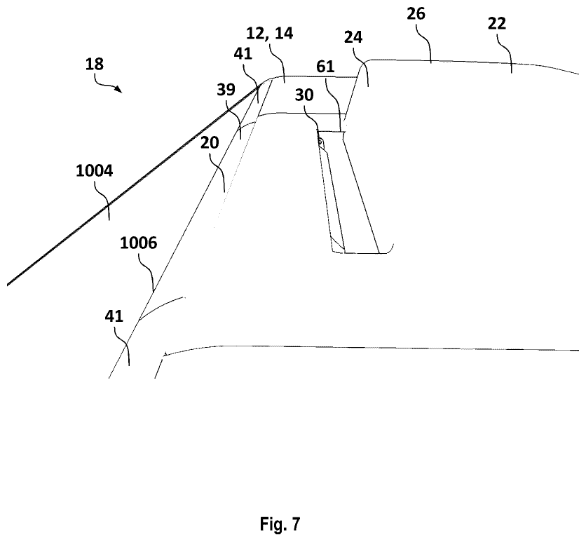

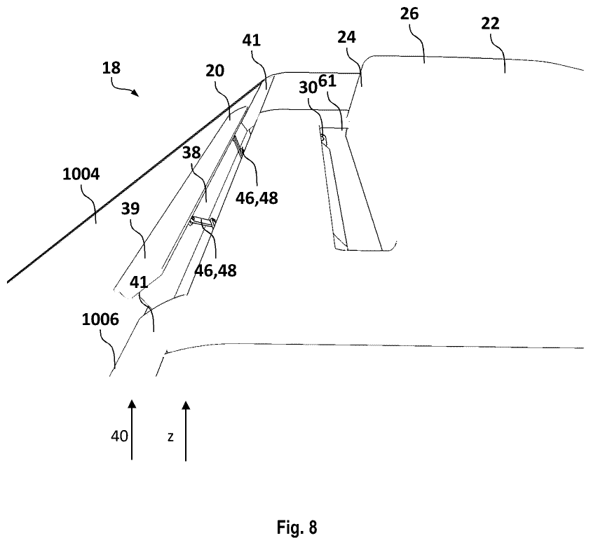

According to a further embodiment, which is shown by way of example and in different variants in FIGS. 7 to 10, in the cleaning position the flow guidance element 20 forms a gap or an opening 38 relative to the upper edge 1006 of the windshield 1004 and/or the surface component 12 and/or to the sensor module 18 which serves to manage the cleaning fluid and/or to guide the flow of the cleaning fluid. The flow guidance element 20 is here formed as part of a seal 39, in particular as a section of a seal 39 of the upper edge 1006, at the roof, of a windshield 1004 of the motor vehicle 1000. The seal 39 can be part of a windshield seal 41. The windshield seal 41 here has a stationary or fixed seal section which runs around the windshield at least in some sections and a movable section which is formed by the seal 39, as is clear in particular from FIG. 8. The flow guidance element 20 can be moved here between the rest position and the cleaning position in a movement direction 40 essentially in a vehicle vertical direction z (see FIG. 8). The flow guidance element 20 can here also be moved at least partially in the vehicle longitudinal direction x, i.e. perform a complex movement. The flow guidance element 20 has, considered in a vehicle vertical direction z, a smaller spacing from the upper edge 1006 or the surface component 12 in the rest position than in the cleaning position.

The sensor module frame 23 can be connected to a vehicle body component or be formed integrally with the vehicle body component. Connection of the sensor module frame 23 to the vehicle body component can be made, for example, by means of an adhesively bonded connection. The sensor module frame 23 forms at least in some sections a fluid collecting container 42 by means of which a cleaning fluid which can be used by the cleaning nozzle 30 to clean the viewing region 24 can be caught and can preferably be channeled away via a drain (not shown) from the sensor module 18 and/or the motor vehicle 1000 (see FIG. 6). The fluid collecting container 42 is in the present case arranged on the sensor module frame 23 as a further frame component but can also be formed integrally with the sensor module frame 23.

The flow guidance element 20 is in the present case arranged by means of an adjustment kinematic system 46, for example, on the sensor module frame 23 or a body component of the vehicle body 1002 and can be moved by the adjustment kinematic system 46 between the rest position and the cleaning position. The adjustment kinematic system 46 has, for example, a hinge mechanism 47 and/or a four-joint mechanism or a multiple-joint mechanism 48 (see in particular FIGS. 8-10) and/or a pushing mechanism and/or a sliding mechanism 49 and/or a carriage mechanism 50 and/or a spring/piston mechanism 51.

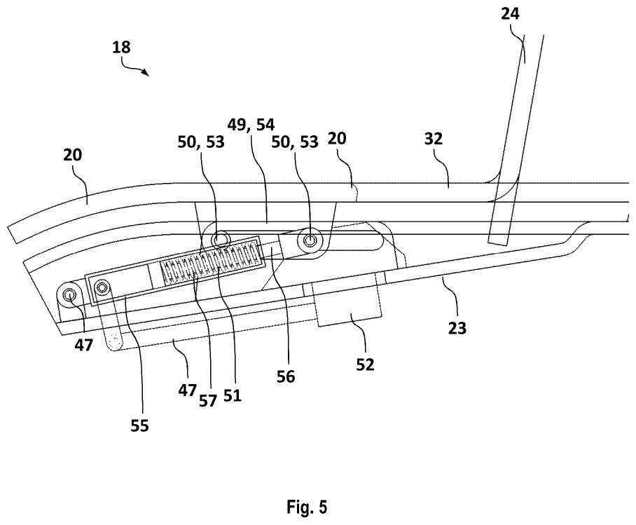

FIGS. 4 and 5 here show a mixture of a hinge mechanism 47, a sliding mechanism 49, a carriage mechanism 50, and a spring/piston mechanism 51.

In this example, the movement of the flow guidance element 20 is achieved by two pins 53 which are arranged at the flow guidance element 20. The pins 53 slide in a guide 54 fastened to the sensor module frame 23. In this example, the movement is controlled by a drive 52. In this example, the drive 52 comprises a cylinder 55 with a piston 56 which is actuated, for example, by the fluid pressure of the cleaning device 19. When the cleaning device 19 is activated, the piston 56 is pushed outward by the pressure of the cleaning fluid and thus moves the guide 54. When the pressure decreases, the piston 56 is retracted by a spring 57 in the cylinder 55 (see FIG. 5). As a result, the guide 54 can be moved in a controlled fashion when it is needed (for cleaning). The return of the guide 54 into the rest position can be delayed by the remaining pressure being maintained in the cylinder 55, by for example a valve (not shown) of the cleaning device 19 not being opened initially. After a predetermined time, for example when all of the cleaning fluid has been collected, the cleaning valve is opened in order to release the pressure and the guide 54 can return to the rest position.

The adjustment kinematic system 46 is driven by the drive 52. The drive 52 can be designed as an electric motor, a linear drive, a pneumatic drive, a magnetic drive and/or the like.

With reference to FIGS. 7 to 10, the movable seal 39 is actuated by the multiple-joint mechanism 48. This multiple-joint mechanism 48 comprises a lever 58 which is, for example, fastened movably on the sensor module frame 23 in a rail 59 (the pivot point can here have a linear manifestation) and is fastened movably (in rotation) on the movable seal 39. In addition, the lever 58 has a pivot point with a further lever 60 which in turn is fastened movably (in rotation) on the sensor module frame 23. When a linearly movable end of the lever 58 is moved, the connection expands and retracts the movable seal 39. Other possible mechanisms are hinge mechanisms, four-joint mechanisms, other multiple-joint mechanisms and/or pushing mechanisms, etc. In this example of FIGS. 7 to 10, the actuation is effected by a cylinder (not shown).

It can be seen overall in FIGS. 1 to 10 that the cleaning nozzle 30 is arranged offset below the surface component 12 in the direction of a vehicle interior in the vehicle vertical direction z. The cleaning nozzle 30 is here arranged, for example, in a depression 61.

### LIST OF REFERENCE SIGNS

10 roof sensor module
12 surface component
14 roof skin
16 fixed roof element
18 sensor module
19 cleaning device
20 flow guidance element
22 environment sensor
23 sensor module frame
24 viewing region
26 sensor housing
28 optical axis
30 cleaning nozzle
32 gap
34 gap
36 movement direction
38 gap
39 seal
40 movement direction
41 windshield seal
42 fluid collecting container
44 drain
46 adjustment kinematic system
47 hinge mechanism
48 multiple-joint mechanism
49 sliding mechanism
50 carriage mechanism
51 spring/piston mechanism
52 drive
53 pin
54 guide
55 cylinder
56 piston
57 spring
58 lever
59 rail
60 lever
61 depression
100 vehicle roof
1000 motor vehicle
1002 vehicle body
1004 windshield
1006 upper edge
x vehicle longitudinal direction
y vehicle width direction
z vehicle vertical direction

1. A sensor module for a motor vehicle having:
an environment sensor,
a viewing region through which the environment sensor captures a vehicle environment, and
a cleaning device which has a cleaning nozzle for cleaning the viewing region,
wherein the cleaning device moreover has a flow guidance element which is adjustable between a rest position and a cleaning position relative to the cleaning nozzle and/or the viewing region, and
wherein the flow guidance element forms in the cleaning position at least one gap for managing the cleaning fluid and/or for guiding the flow of the cleaning fluid.

2. The sensor module as claimed in claim 1, wherein the flow guidance element is arranged, in the rest position, at least in some regions flush with a surface component, adjoining the sensor module, of the motor vehicle, and/or wherein the flow guidance element, in the rest position, adjoins an upper edge, at the roof, of a windshield of the motor vehicle in particular gap-free.

3. The sensor module as claimed in claim 1, wherein the flow guidance element, considered in a vehicle longitudinal direction, has a larger spacing from the viewing region in the rest position than in the cleaning position, or wherein flow guidance element has, considered in a vehicle vertical direction, a smaller spacing from an upper edge of a windshield in the rest position than in the cleaning position.

4. The sensor module as claimed in claim 1, wherein the flow guidance element is movable between the rest position and the cleaning position essentially in a vehicle longitudinal direction, or wherein the flow guidance element is movable essentially in a vehicle vertical direction between the rest position and the cleaning position.

5. The sensor module as claimed in claim 1, wherein the flow guidance element, in the cleaning position, delimits the at least one gap with respect to the viewing region with respect to a lower edge of the viewing region, and/or relative to an upper edge, at the roof, of a windshield of the motor vehicle, wherein the at least one gap is designed for managing the cleaning fluid and/or guiding the flow of the cleaning fluid.

6. The sensor module as claimed in claim 1, wherein the sensor module moreover has a sensor module frame which is connectable to a vehicle body component or formed integrally with the vehicle body component.

7. The sensor module as claimed in claim 6, wherein the sensor module frame at least in some sections forms a fluid collecting container by which a cleaning fluid which is used by the cleaning nozzle for cleaning the viewing region is caught and is channeled away via a drain from the sensor module and/or the motor vehicle.

8. The sensor module as claimed in claim 6, wherein the flow guidance element is arranged on the sensor module frame by an adjustment kinematic system and is moveable by the adjustment kinematic system between the rest position and the cleaning position.

9. The sensor module as claimed in claim 8, wherein the adjustment kinematic system has a hinge mechanism and/or a four-joint mechanism and/or a multiple-joint mechanism and/or a pushing mechanism and/or a sliding mechanism and/or a carriage mechanism and/or a spring/piston mechanism.

10. The sensor module as claimed in claim 1, wherein the flow guidance element is designed as part of a seal of an upper edge at the roof, of a windshield of the motor vehicle.

11. A vehicle roof of a motor vehicle, comprising at least one sensor module as claimed in claim 1.

12. A motor vehicle, comprising a vehicle roof, the vehicle roof comprising at least one sensor module as claimed in claim 1.

13. The sensor module as claimed in claim 10, wherein the flow guidance element is designed as a section of a seal, of an upper edge, at the roof, of a windshield of the motor vehicle.

14. The motor vehicle roof of claim 11, wherein the vehicle roof forms a roof sensor module which is arranged as a pre-assembled structural unit on a vehicle body of the motor vehicle.

15. The motor vehicle of claim 12, wherein the vehicle roof forms a roof sensor module which is arranged as a pre-assembled structural unit on a vehicle body of the motor vehicle.
